(19) United States
(12) Patent Application Publication
(10) Pub. No.: US 2012/0253872 A1
(43) Pub. Date: Oct. 4, 2012

(54) ROLE MAPPING AND TRAINING TOOL

(75) Inventors: Deborah A. Peters, London (GB); Timothy I. Gobran, Birmingham, AL (US); Ranjit A. Singh, Haryana (IN); Emma C. Potter, Kent (GB); Bharat Gosai, Essex (GB)

(73) Assignee: Accenture Globel Services Limited, Dublin (IE)

(21) Appl. No.: 13/436,230

(22) Filed: Mar. 30, 2012

Related U.S. Application Data
(60) Provisional application No. 61/469,288, filed on Mar. 30, 2011.

(51) Int. Cl. G06Q 10/06

(52) U.S. Cl. 705/7.13

(57) ABSTRACT

A role mapping and training tool may include a rule-based system determining parameters for tasks, roles, jobs, individuals, and training courses, and determining mappings between the tasks, roles, jobs, individuals, and training courses. The system may utilize segregation rules to determine mappings between roles and jobs that are acceptable. Also, from the mappings, training plans may be generated.

### PRIORITY

The present application claims priority to U.S. Provisional Patent Application Ser. No. 61/469,288, filed on Mar. 30, 2011, entitled “Role Mapping and Training Tool”, which is incorporated by reference in its entirety.

### BACKGROUND

Managing and implementing role mapping and training of an organization's work force has become increasingly important for efficient and effective utilization of the organization's work force and resources. While many factors influence an organization's ability to achieve high performance, none may be more important than the effective role mapping and training of its work force for specialized roles and tasks within the organization. This is particularly relevant for larger organizations associated with emerging technologies and/or advanced service types. Technology, organizational strategy, and the development of innovative new products and services are all important. However, it is an organization's work force which drives it forward, enabling the organization to translate its projects and goals into results. The training of work force members for their assigned roles within an organization is key for successful operations. Accordingly, effective planning and implementation for educating and/or training the work force of an organization is important in helping the organization to reach its long-term and short-term goals.

Nevertheless, the effective planning and implementation of role mapping and work force training has become increasingly difficult. This is often due to the growing complexity of organizational structures in the modern economy. In addition, individuals who are highly trained or have a specialized skill setare often the most sought after for employment by organizations competing, often, on a world-wide basis. These types of individuals commonly resign and relocate with great fluidity. Furthermore, internal and external forces upon organizational work forces, such as volatile economic conditions and changes in the labor market, often present multiple impediments to work force training.

### SUMMARY

According to an embodiment, a role mapping and training (RMT) method includes determining training course parameters for an entity; determining role and job parameters for the entity; mapping roles to jobs based on the role and job parameters; mapping training courses to the jobs based on the training course parameters and the role to job mappings; and determining a training plan from the mappings for training courses to jobs and the mappings for roles to jobs, wherein the training plan identifies at least one of the training courses for each job.

According to another embodiment, an RMT system includes a data storage to store role and job parameters and training course parameters for an entity and a processor to retrieve the training course parameters for the entity; retrieve the role and job parameters for the entity; map roles to jobs based on the role and job parameters; map training courses to the jobs based on the training course parameters and the role to job mappings; and determine a training plan from the mappings for training courses to jobs and the mappings for roles to jobs, wherein the training plan identifies at least one of the training courses for each job.

The method includes steps that may be embodied as machine readable instructions that are executable by a processor to perform the steps. The machine readable instructions may be stored on a non-transitory computer readable medium.

### BRIEF DESCRIPTION OF THE DRAWINGS

Embodiments are described in detail in the following description with reference to the following figures. The embodiments are illustrated by way of example and are not limited by the accompanying figures in which like reference numerals indicate similar elements.

FIG. 1 shows a system architecture of a role mapping and training (RMT) tool context diagram illustrating an on-premises context for an RMT tool;

FIG. 2 shows a computer system that may be a platform for the RMT tool;

FIG. 3 shows modules that may be in the RMT core;

FIG. 4 shows a logical view of some of the operations performed by the RMT tool;

FIGS. 5A-C show examples of mapping performed by the RMT tool;

FIG. 6 shows an example of fields that may be included in tables used by the RMT tool;

FIG. 7 is a flow diagram illustrating a method that may be performed by the RMT tool; and

FIGS. 8-12 show examples of screenshots that may be generated by the RMT tool.

### DETAILED DESCRIPTION

For simplicity and illustrative purposes, embodiments of the invention are described by referring mainly to examples thereof. Also, numerous specific details may be set forth in order to provide a thorough understanding of the embodiments. It is apparent however, to one of ordinary skill in the art, that the embodiments may be practiced without limitation to these specific details and examples. Also, in some instances, well known methods and structures have not been described in detail so as not to unnecessarily obscure the description of the embodiments. Furthermore, different embodiments are described below. The embodiments may be used or performed together in different combinations.

According to an embodiment, a Role Mapping and Training (RMT) tool, which is described in greater detail below, facilitates performance of integrated, structured and efficient role mapping functions as well as training plan design and implementation for an organizational work force. Role mapping may include mapping roles to tasks, jobs and individuals in the organization. A role may include responsibilities to perform certain tasks. The tasks may include actions performed to execute processes within the organization. The tasks may include tasks to be performed for each job. Mapping includes creating an association between at least two data elements. For example, a mapping between a role and a job may be stored as an association between the role ID and the job ID for the role and job. In at least some instances, mappings can be bidirectional. For example, a mapping for role X to job Y also indicates that job Y is mapped to role X.

The RMT tool is operable to gather data from multiple sources to operate as a single source of data to support the mapping functions as well as other functions performed by the RMT tool. The RMT tool may include a data integration layer that interfaces with internal enterprise systems and external systems to perform mass uploads into a data repository for the RMT tool. The internal systems may include enterprise resource planning (ERP) applications, learner management system applications, and other types of applications and systems. The data interface layer may convert received data to schemas used by the RMT tool to perform its role mapping and other functions.

The RMT tool also may simplify Segregation of Duties (SoD) analysis and resolution, and enables efficient and integrated reporting to overcome SoD role mapping conflicts.

The RMT tool utilizes a core functionality with customization options available for an organization's specific needs. Thus, the RMT tool can be easily re-purposed for different types of organizations and for different industries, such as information technology (IT), sales and marketing, accounting, etc. For example, different database instances and web interfaces may be created for each organization. Also, different mapping rules may be stored for each organization, and the RMT tool core can determine the mappings for each organization based on their specific information stored in their database instance.

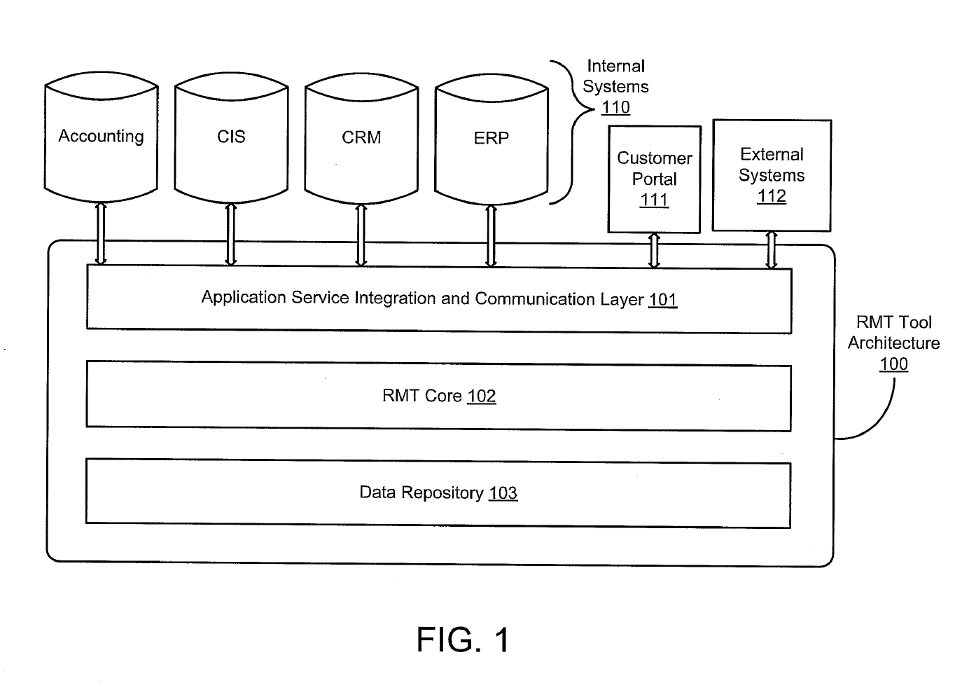

FIG. 1 illustrates a system architecture 100 of the RMT tool. The RMT tool may be implemented as software stored on a non-transitory computer readable medium and executed by one or more processors. The architecture 100 may represent a software architecture.

The architecture 100 includes an application service integration and communication layer 101, RMT core 102 and data repository 103. The application service integration and communication layer 101 supports data collection from internal systems 110 of a user, which may include ERP applications and other applications. The layer 101 also provides secured access with user/customer portals 111 and external third party portals and systems 112. The layer 101 may utilize a full featured web services library to support the user/customer portals 111 and external third party portals and systems 112. Generally, the layer 101 provides a mechanism for interfacing with the different systems and web interfaces so the RMT tool can function as a single source of data to provide its role mapping, training design and scheduling services.

The layer 101 provides data collection from enterprise resources and other sources in the internal system 110. The layer 101 may include application program interfaces (APIs) to communicate with the internal systems 110. For example, the internal systems 110 may include enterprise applications providing functions for accounting, customer information system (CIS), enterprise resource planning (ERP), customer relationship management (CRM), etc. The layer 101 receives data from the enterprise applications, for example, through APIs or other interfaces and may normalize the data for storage in data repository 103. Normalizing may include formatting according to predetermined schemas. For example, the layer 101 identifies types and categories or fields from data received from the internal systems 110, customer portal 111 or external systems 112. The layer 101 maps the received data to schemas of tables in the data repository 103 based on the determined types and fields. Then, the data may be stored in tables in the data repository 103. The data repository 103 may include a database using the tables.

Some of the information stored in the data repository 103 may include details for jobs, roles, work force individuals, training courses and other information used for mapping. The data repository 103 may store rules for performing the mappings. These rules may be implemented as part of an expert rule-based system in the RMT tool that performs the role mapping, including segregation of duties, and other mappings described herein.

The RMT core 102 performs the functions of the RMT tool. For example, the RMT core 102 includes mapping functions, analytics capabilities for supporting role mapping and training activities, reporting functions, scheduling functions and other functions. For example, the core 102 may be utilized in developing and/or evaluating organizational training plans and scheduling. The core 102 may include a role design function, a training design function and a mapping design function. The core 102 includes a reporting function as well.

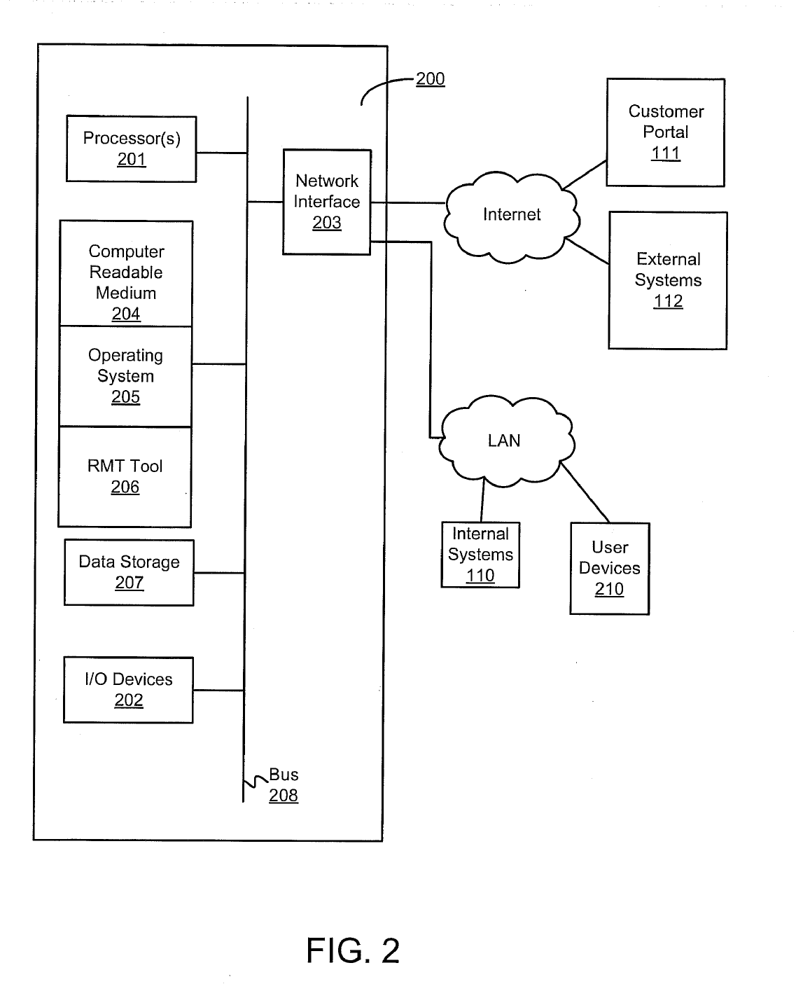

FIG. 2 illustrates a computer system 200 that may be used to implement the RMT tool. It is understood that the illustration of the computer system 200 is a generalized illustration and that the computer system 200 may include additional components and that some of the components described may be removed and/or modified. Also, the RMT tool may be implemented in a distributed computing system, such as a cloud computer system. For example, the computer system 200 may represent a server that runs the RMT tool or the computer system 200 may comprise one of multiple distributed servers that performs functions of the RMT tool.

The computer system 200 includes processor(s) 201, such as a central processing unit, ASIC or other type of processing circuit; input/output devices 202, such as a display, mouse keyboard, etc., a network interface 203, such as a Local Area Network (LAN), a wireless 802.11x LAN, a 3G or 4G mobile

WAN or a WiMax WAN, and a computer-readable medium 204. Each of these components may be operatively coupled to a bus 208. The computer readable medium 204 may be any suitable medium which participates in providing instructions to the processor(s) 201 for execution. For example, the computer readable medium 204 may be non-transitory or non-volatile media, such as a magnetic disk or solid-state non-volatile memory or volatile media such as RAM. The instructions stored on the computer readable medium 204 may include machine readable instructions executed by the processor(s) 201 to perform the methods and functions of the RMT tool.

The computer readable medium 204 may store an operating system 205, such as MAC OS, MS WINDOWS, UNIX, or LINUX, and one or more applications 206, which include the RMT tool. The operating system 205 may be multi-user, multiprocessing, multitasking, multithreading, real-time and the like.

The computer system 200 may include a data storage 207, which may include non-volatile data storage. The data storage 207 stores any data used by the RMT tool. The data storage 207 may be used for the data repository 103 shown in FIG. 1 or the computer system 200 may be connected to a database server (not shown) hosting the data repository 103.

The network interface 203 connects the computer system 200 to the internal systems 110, for example, via a LAN. End user devices 210 and other computer systems/servers may connect to the computer system 200 via the network interface 203. Also, the network interface 203 may connect the computer system 200 to the Internet. For example, the computer system 200 may connect to customer portals 111 and external systems 112 via the network interface 203 and the Internet.

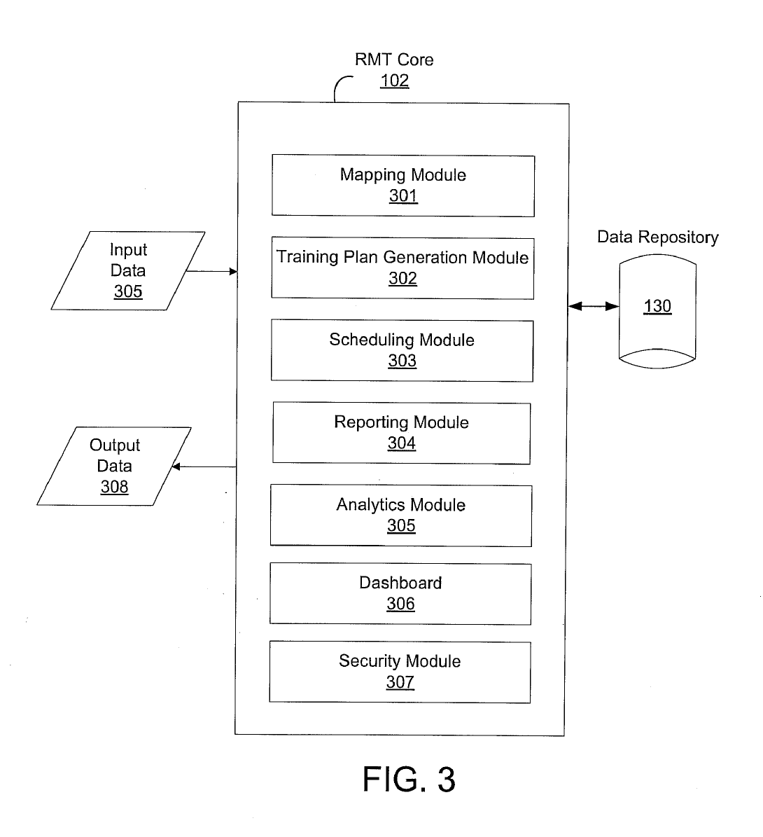

FIG. 3 shows an example of modules that perform the functions of the RMT tool. A module comprises machine readable instructions that are executable by a processor to perform one or more functions. The modules shown in FIG. 3 may be part of the RMT core 102 shown in FIG. 1.

The RMT tool may include a mappings module 301, a training plan generation module 302, a scheduling module 303, a reporting module 304, an analytics module 305, a dashboard 306 and a security module 307. The components 301-307 provide the functionality of the RMT tool. For example, the mapping module 301 may comprise a rule-based expert system to perform mappings based on the parameters. Rules may be stored in the data repository specifying conditions for mapping tasks, roles, jobs, training courses etc. Generally, a rule used for mapping may identify one or more conditions and an action to be performed for the mapping. Rules may specify one or more conditions for generating a mapping or conditions for excluding a mapping. If a condition in a rule is met, then a mapping may be generated and stored in the data repository 103. In one example, a rule specifies that a role for a specific process and including a specific set of tasks is to be mapped to a particular job.

The mapping module 301 may also operate as an SoD engine. For example, when determining mappings, the mapping module 301 may also include checking for segregation of duties. For example, the rules for mapping may include SoD rules. An SoD rule may identify roles, jobs, or tasks that are to be segregated and may include a trigger for the segregation, such as the segregation is for a particular process or country. Also, an SoD rule may identify exceptions to the segregation and may provide rationale for the segregation.

The SoD rules can function to segregate two or more roles which should not be performed by the same person. In one example of an SoD rule, the rule specifies that a task must be mapped to a particular role and cannot also be mapped to different role. For example, the rule may specify that tasks for a purchasing role cannot also be mapped to a purchase approval role. When mappings are performed, these rules may be executed so one job is not assigned to two roles that are required to be segregated.

The training plan generation module 302 generates a training plan based on mappings determined by the mapping module 301. The training plan may identify training courses to be attended by individuals and information about the training courses, such as course name, location, time and date, etc. The scheduling module 303 may interface with an application in the internal systems 110 to automatically schedule training courses for individuals. The reporting module 304 generates reports, and examples of the reports are described in further detail below. Also, the reporting module facilitates users to customize reports.

The analytics module 305 may estimate which courses or jobs are best for each individual or role. In one example, the analytics module 305 uses mappings determined by the mapping module 301 to determine the courses or jobs that are best for each individual or role. For example, User A is mapped to Job B, and Job B is mapped to Role C, and Role C is mapped to Course D:

User A→Job B→Role C→Course D.

The analytics module 305 determines that User A should be mapped to Course D by default, and the mapping module 301 may then create and store the mapping from User A to Course D. This example is further illustrated by the following: User=James Smith; Job=Procurement Manager; Role=Approve Invoice; and Course=Manage Purchasing. In this case, James is mapped to the Job ‘Procurement Manager’, and this job is mapped to the ‘Approve Invoice’ role, and if this role is mapped to the ‘Manage Purchasing’ course, then the analytics module 305 analyzes the mappings to determine that James is to be mapped to the ‘Manage Purchasing’ course.

The dashboard 306 may comprise a graphic user interface for users to interface with the RMT tool. The users may enter data into the RMT tool and view reports and other information via the dashboard 306. The security module 307 may perform authentication and control access to data so unauthorized individuals cannot access stored data. Active directory may be used by the security module 307 to control data access.

The RMT tool receives input data 305 which may include parameters for mappings and other information. The parameters are described in further detail below. The input data 305 may also include rules for performing mapping. The input data 305 may include data from the internal systems 110, from users and the external systems 112. The output data 308 may include reports generated by the reporting module 304 or other information generated by the RMT tool. Although not shown, input data 305 and output data 308 may be communicated via layer 101 shown in FIG. 1.

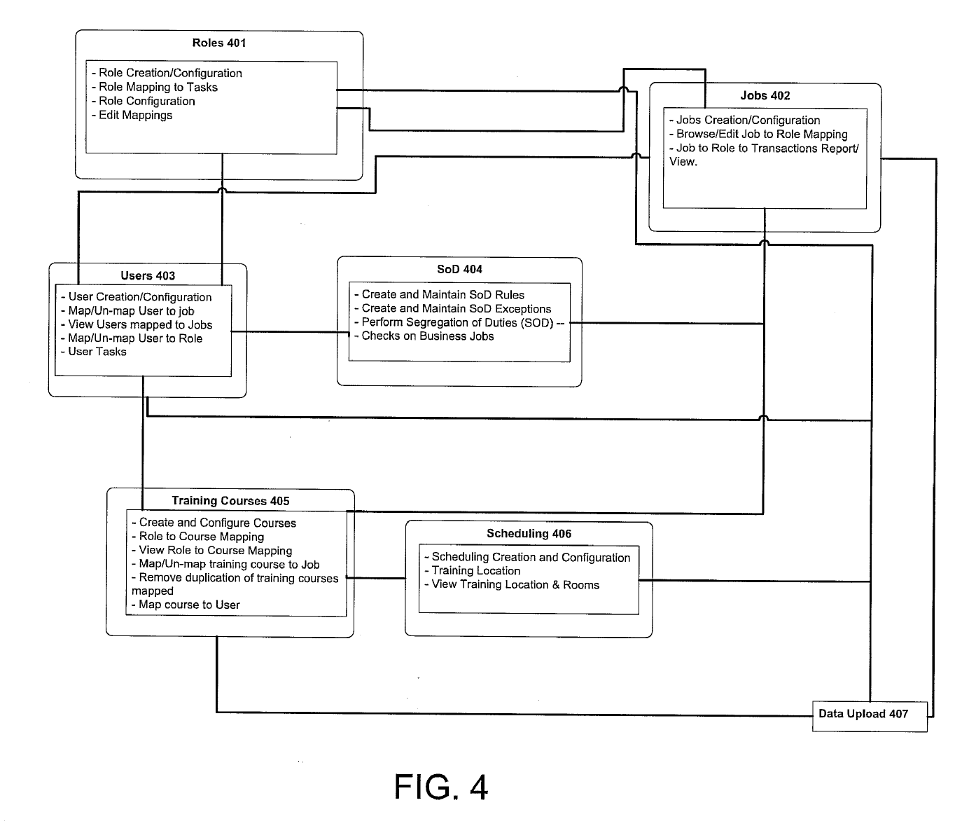

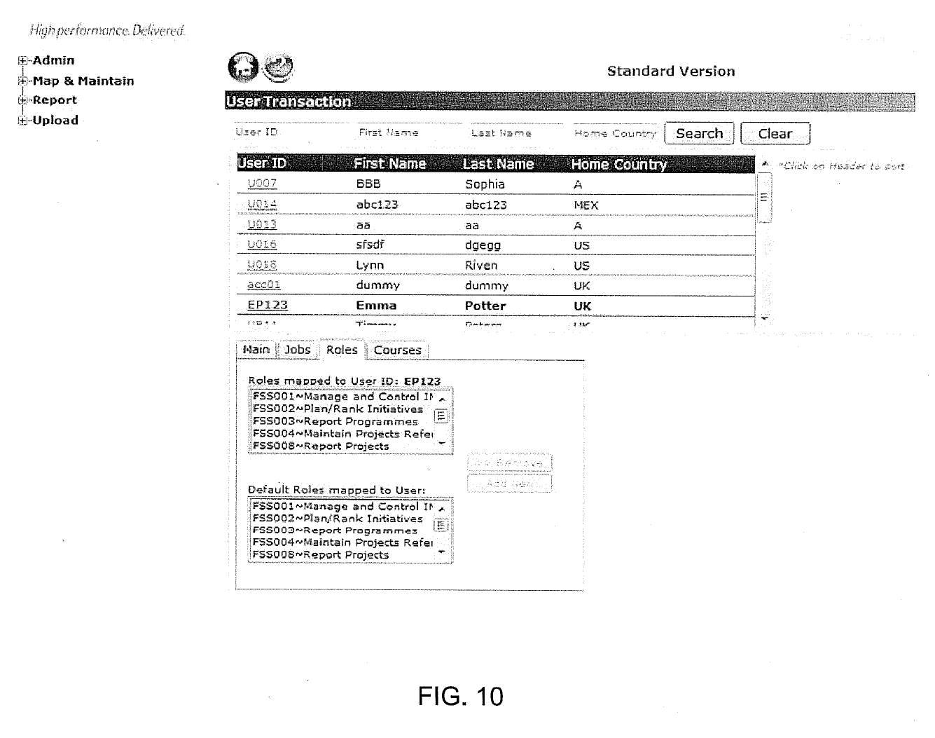

FIG. 4 shows a logical view of some of the operations performed by the RMT tool, including the modules shown in FIG. 3. For example, operations 401 with respect to roles may include creating and configuring roles, mapping roles to tasks and storing information for roles in the data repository 103. When creating roles, jobs, users, etc., parameters for each may be received, for example, from a user or a system and stored in the data repository 103. Also, mappings may be edited for roles, jobs, users, courses, etc. A screenshot for editing mappings is shown in FIG. 10. Operations 402 with respect to jobs may include creating and configuring jobs, mapping jobs to roles, individuals and tasks and reporting.

Reporting may be performed for all types of mappings. Operations 403 for users may include creating and configuring users, editing mappings, including creating mappings and deleting mappings, reporting and identifying tasks. Operations 404 for SoD may include creating and maintaining SoD rules and exceptions, and performing segregation of duties to maintain checks on business jobs. Operations 405 for training may include creating and configuring courses, mapping roles to courses and users, editing mappings and reporting. Scheduling operations 406 may include creating and configuring training schedules, mapping training locations to courses and reporting. Data upload 407 includes storing data for individuals, tasks, roles, jobs and courses in the data repository 103. Other operations may be performed by the RMT tool as well. For example, multiple implementations may be created. An implementation is a deployment of an instance of the RMT tool, which may include a web site, layers 101 and 102 shown in FIG. 1, a database and/or other data storage. An implementation may comprise one or more geographic regions. For example, implementation 1 covers Singapore and implementation 2 covers Belgium, Netherlands, and Luxembourg. The RMT tool may create, edit and store mappings to implementations, such as mappings of implementations to individuals, roles, jobs, courses, etc. Other operations may include reporting, audit trail generation that may include logs identifying users, their actions performed on the tool, timestamps, etc. Other operations may include security management, such as login ID and password management and other security requirements including authentication.

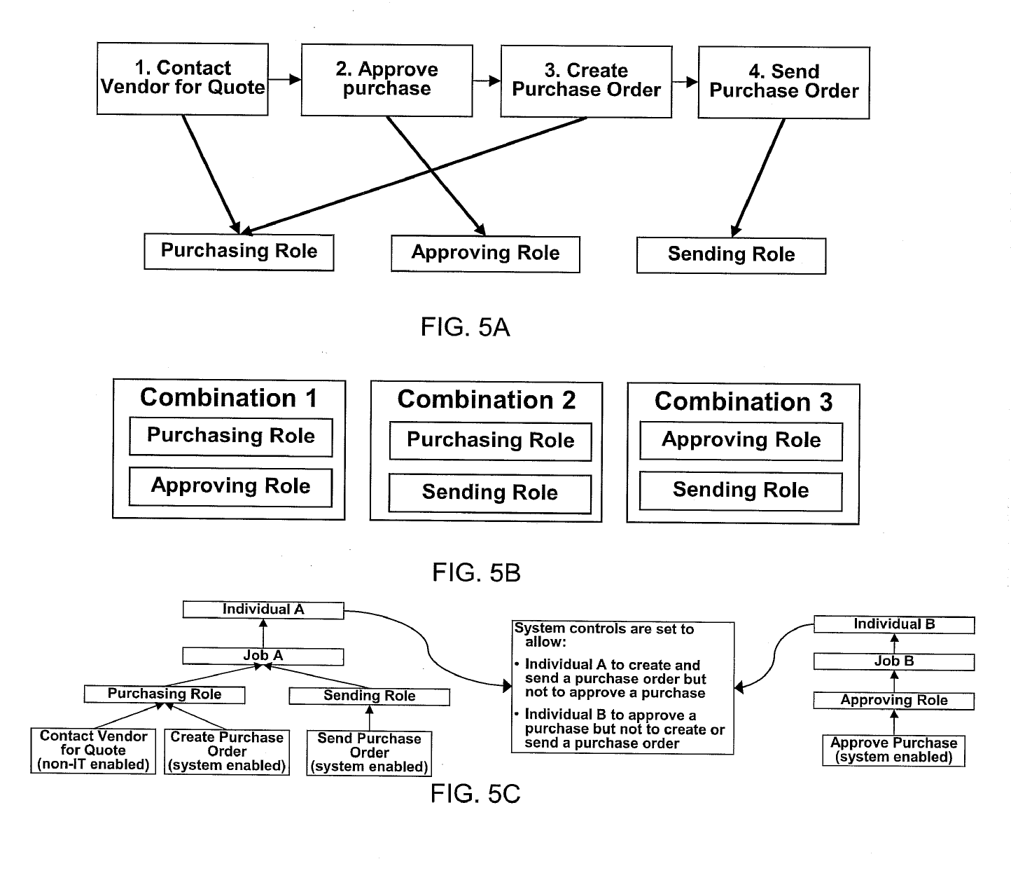

FIGS. 5A-C show examples of generating mappings. A process defines the content and sequence of individual tasks. In the example shown in FIG. 5A, the process includes a business process for sending a purchase order. The tasks for sending a purchase order are determined and entered into the RMT tool. The tasks include contact vendor for quote; approve purchase; create purchase order; and send purchase order. Roles are also determined and entered into the RMT tool. The roles may include logical groupings of tasks. For example, the roles may include a purchasing role, an approving role, and a sending role. Tasks are mapped to each role as shown in FIG. 5A. The mappings may be entered by a user and stored. A business process may include business controls to mitigate identified risks in the process. The controls may be saved as SoD rules that are implemented by an SoD engine which may be part of the mapping module 301 as described above. The mapping module 301 may use the SOD rules to impart the business controls when performing mapping. For example, the business controls specify that one individual should not be allowed to approve and purchase an order so these roles must be assigned to different individuals. Based on this business control, an SoD rule is created and stored that indicates the purchasing role and the approving role cannot be in the same combination. This SoD rule is used to map individuals to roles and jobs and tasks. For example, FIG. 5B shows combinations 1-3 of the roles shown in FIG. 5A. Combination 1 includes the purchasing role and the approving role assigned to the same person. Based on the SoD rule that purchasing and approving cannot be performed by the same person, the mapping module 301 would not map the same person to both of these roles. Thus, combination 1 is improper. Combinations 2 and 3, however, are proper. For example, the same person can be assigned to the purchasing and sending roles or the approving and sending roles, such as shown in combinations 2 and 3. Thus, the RMT tool may determine combinations of roles that can be assigned to the same job based on the mappings of tasks to rules and the SoD rules, and then a combination of roles may be selected to map to a job.

FIG. 5C shows an example of mapping jobs to roles and individuals to jobs. For example, based on the SoD rule that purchasing and approving cannot be performed by the same person, the mapping module 301 determines that the approving role cannot be assigned to the same job as the purchasing role. Also, the mapping module maps individuals to jobs in a similar fashion. For example, as shown in FIG. 5C, the mapping module 301 can map individual A to job A because job A does not include both purchasing and approving and individual B can be assigned to job B because it only includes approving.

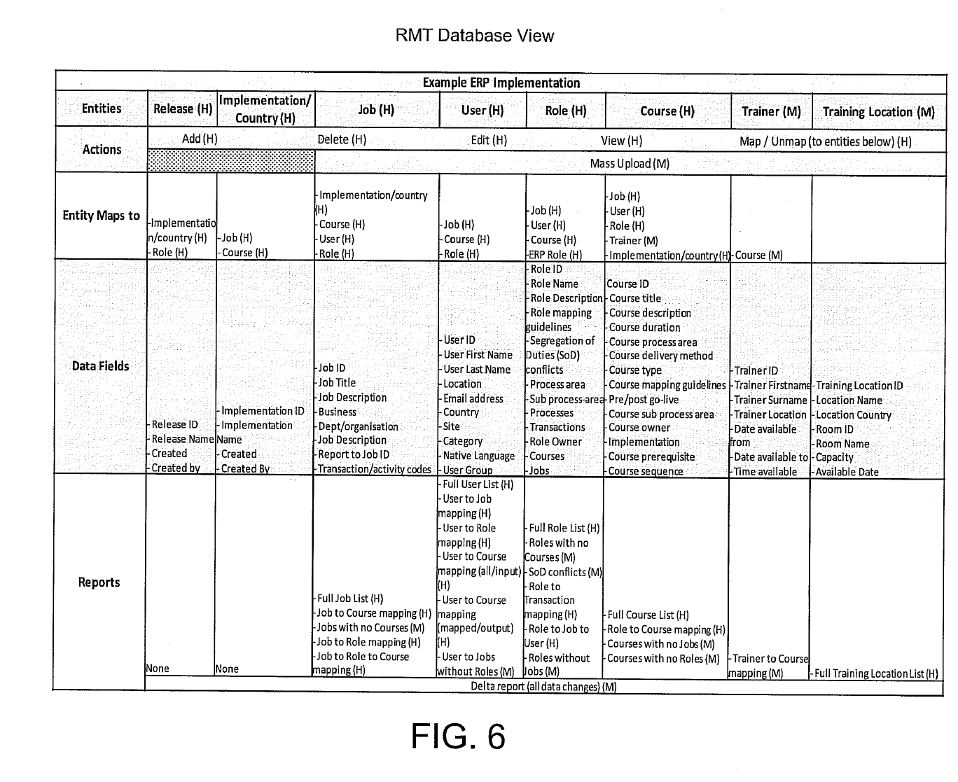

FIG. 6 shows an example of data stored in tables in the data repository 103. In this example, the “entities” represent the primary data tables utilized in an RMT database and the “actions” represent sources for the entities. The “data fields” list the fields utilized within each entity table. The “entity maps to” represents potential relationships between the different entities, such as the user entity mapping to the entities for job, course and role. A report list for the entities is also demonstrated.

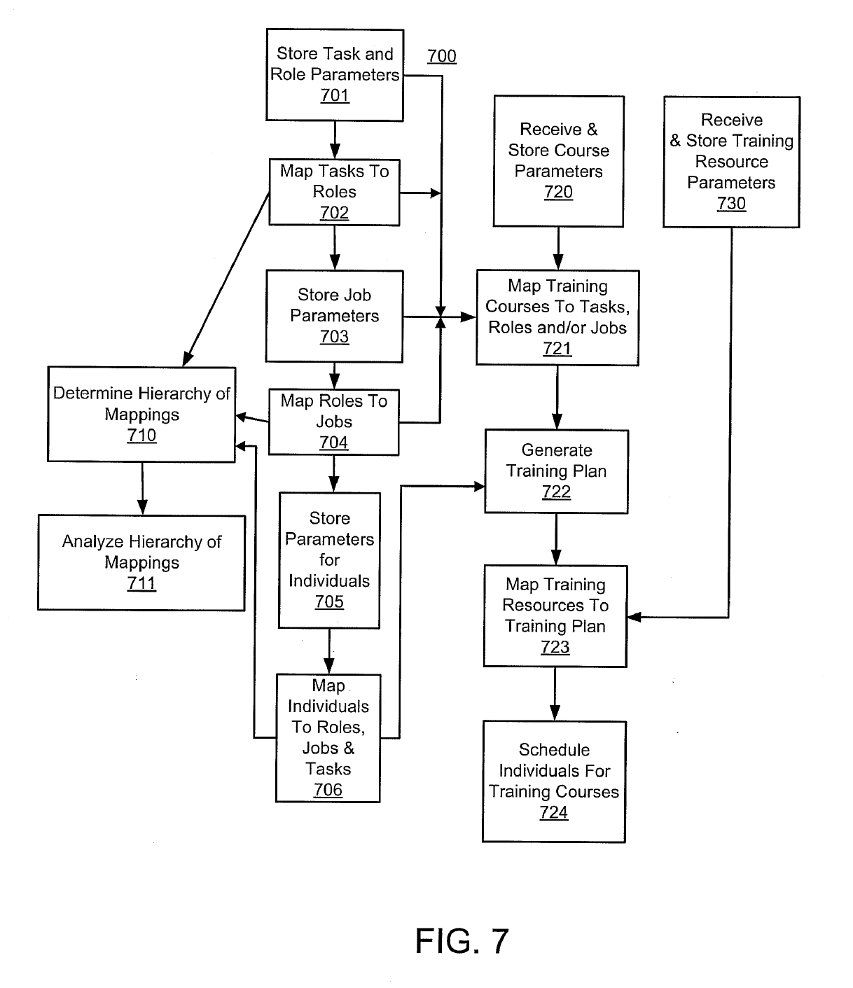

FIG. 7 illustrates a method 700 that may be performed by the RMT tool according to an embodiment. The steps of the method 700 may be performed in a different order than shown and some of the steps may be performed simultaneously.

At 701, the RMT tool determines tasks for processes performed by a company, an organization or some other type of entity. Information, such as task parameters for the tasks, is determined and stored in the data repository 103. The information may include unique IDs for each task, process areas and sub process areas associated with the tasks, descriptions of the tasks, individuals that perform the tasks if known, and other parameters associated with the tasks. The task parameters may be entered by a user via the dashboard 306. Role parameters may also be stored at 701 or subsequently stored, such as when mapping tasks to roles.

At 702, the mapping module 301 maps tasks to roles. The tasks are logically grouped based on their parameters. For example, the mapping module 301 may determine the logical groupings based on one or more parameters of the tasks and the groups are stored as roles. For example, all the tasks associated with a particular individual are grouped. In another example, all tasks for a particular process or sub process are grouped. A process refers to a predetermined sequence of steps that are to be completed in order to produce a specific result. For example, a process may be to manage financial accounting, and the sub processes may include managing a general ledger, perform closing, and accounts payable. In another example, a process area may include a category associated with a set of processes in a company, such as an accounting process area or an information technology process area, and a sub process area is a subcategory under the process area, such as payroll or purchase order management for accounting. Process areas may be specified for tasks, roles, jobs, individuals, training courses, etc.

In one example, the mapping module 301 determines the groupings based on the task parameters, and a user may view the groupings and the tasks under each grouping via the dashboard 306. The user may add/delete tasks under each grouping and store the groupings as roles. Each role is stored with role parameters and tasks under a role may include a role ID for the role to associate the task with the role.

Examples of the role parameters may include Role ID, Role Name, Role Description, Role Owner, Sub Process Area, Process Area, Process Reference, and Comments. The process area and sub process area may refer to a business process and/or sub process. The role description may identify tasks associated with the role. A user of the RMT tool may search for a role using one or more of the role parameters, such as Role ID, Role Name, Process Area, etc. Also, a user may create, view and edit roles and their parameters through, for example, the dashboard 306. A user may delete a role. If a role is deleted, its mappings may also be deleted, such as mappings for role to job, role to course, and role to individual, which may be stored in their respective tables.

Also at 702, the mapping module 301 may use SoD rules to map tasks to roles. An example of using an SoD rule for mappings is described with respect to FIGS. 5A-C.

At 703, job parameters for the entity are stored in the data repository 103. At least some of the task, role and job parameters may be received, for example, from the internal systems 110 of the entity or external systems 112 via the application service integration and communication layer 101, which is shown in FIG. 1. Also, the parameters may be entered by a user into the RMT tool and stored in the data repository 103. A user may also enter, search, view edit, and delete parameters via dashboard 305, shown in FIG. 3, for the RMT tool.

Examples of job parameters may include Job ID, Job Title, Job Description, Organization, Report to ID, Business, and Transactional Job. The Job ID (and the Role ID) may be unique. A user may create, view, edit and delete jobs.

At 704, the mapping module 301 maps roles to jobs, for example, based on the role and job parameters determined from step 701 and based on SoD rules. As described with respect to FIG. 3, the mapping module 301 may comprise a rule-based expert system to perform mappings based on the parameters. SoD rules may specify conditions for assigning roles to jobs, and then based on the SoD roles, the mapping module 301 determines combinations of one or more roles assigned to each job. Also, parameters for roles and jobs can be used to determine the mappings. For example, if a job and a role are assigned to the same sub process area, then the roles may be initially grouped under the same job. However, the SoD rules map specify that two or more of the rules cannot be performed by the same person, and then the mapping module 301 segregates those roles to different jobs, such as shown in the example in FIG. 5C. In addition to the SoD rules, mapping rules used by the mapping module 301 may specify other conditions for mapping a role to a job. For example, a condition may specify that no more than 3 roles can be assigned to a particular job in a particular sub process area.

Also, a user of the RMT tool may enter or edit mappings. Once a mapping is created, it is stored in the tables of the data repository 103. Therefore, the mappings can be queried and viewed by the user.

At 705, the RMT tool receives and stores parameters for individuals. The individuals may be employees in the company or organization. Examples of the parameters for individuals may include User ID, User Category, User Group, Title, First Name, Last Name, Location, Email, Department, Country and Native Language. The parameters may be received from one or more of internal systems 110, external systems 112, and users. A user of the RMT tool may query, create, view, edit and delete individuals and corresponding mappings.

At 706, the mapping module 301 maps individuals to roles and jobs and tasks. Information received from the internal systems 110 may already indicate some of the mappings identifying which individuals are assigned to which jobs. These mappings may be stored in the data repository 103. Also, individuals may be mapped to roles and jobs and tasks based on mapping rules including SoD rules.

At 710, the RMT tool may determine a hierarchy of mappings of tasks to roles to jobs to individuals, such as shown in FIG. 5C. The mappings may be presented for an entire organization or for a portion, such as for a process area. The mappings can be viewed via the dashboard 306.

At 711, the RMT tool may analyze the hierarchy of mappings determined at 710. The analysis may include comparing the mappings to an organization chart and determining whether there are any discrepancies, such as whether roles have been under-assigned to a particular section of the organization or over-assigned to a particular section. The organization chart may identify each employee and identify the employees under higher level employees, such as managers and team members under each manager.

At 720, the RMT tool receives and stores training course parameters. Examples of these parameters may include Course ID, Course Title, Implementation, Course Description, Course Mapping Guidelines, Course Owner, Pre/Post Go Live, Delivery Method, Course Duration, Process Area, Course Status, Sub Process Area and Course Perquisite. The parameters may be received from one or more of internal systems 110, external systems 112, and users. A user of the RMT tool may query, create, view, edit and delete training courses and corresponding mappings.

At 721, the RMT tool maps the training courses to tasks, roles and/or jobs. Information received from the internal systems 110 may already indicate some of the mappings. These mappings may be stored in the data repository 103. Also, jobs may be mapped to training courses by a user of the RMT tool and/or by the mapping module 301.

The mappings that are determined, for example, at steps 702, 704, 706 and 721, between tasks, roles, jobs, individuals and training courses are stored in the data repository 103 and can be accessed by the RMT tool. The RMT tool, for example, via the training plan generation module 302, uses these mappings to generate a training plan at 722. The training plan, for example, identifies the training courses for one or more of each role, job and individual based on the mappings. The training plan may specify the training courses mapped to each individual so the individual can be scheduled for the courses.

At 723, the RMT tool maps training resources to the training plan. For example, training resource parameters are determined at 730. The training resource parameters may include Trainer ID, Trainer First Name and Last Name, Trainer Location, Trainer Availability Dates and Times, Course Location (country/city/room), Capacity, Course ID, Course Title, Duration, and Process Area. The training resources may be uploaded into the data repository from internal or external systems and/or entered by a user. The mapping module 301 maps the training resources to the training courses in the training plan based on the mapped training resource parameters. For example, trainers, training course locations and training course times are determined for each training course in the plan.

At 724, the RMT tool performs training course scheduling. For example, the scheduling module 303 identifies the jobs mapped to each training course and the individuals mapped to each job. The scheduling module 303 identifies training course locations and times for each individual based on the mappings determined at step 723. The scheduling module 303 may interface with an internal system via the layer 101 to place a training course on an individual's schedule or send a communication (e.g., email, text, voicemail) to the individual indicating the assigned training course, schedule and location.

The RMT tool, for example through reporting module 304, is operable to generate many different reports to present the mappings and other information stored in the data repository 103. The reports may be presented via the dashboard 306 or distributed electronically, for example, via email. Reports can be customized by a user. For example, a user may select fields for a report. Some examples of reports that may be generated by the RMT tool are now described. The RMT tool can generate reports that list tasks, roles, jobs, courses, course resources, training plans, and schedules. One or more parameters for each of these items can be included in the reports. For example, a report listing roles may include one or more of the following parameters: RoleID, RoleTitle, RoleDescription, segregation rules and conflicts (e.g., roles always/never to be combined), ProcessAreaID, SubProcessAreaID, Processes (the role is involved in), RoleOwner, ImplementationID and RoleMappingGuidelines.

Reports may be generated that list the mappings between tasks, roles, jobs, courses, course resources, training plans, and schedules. These reports may also include parameters for the items. For example, a job to course mapping report may be generated that includes one or more parameters, such as JobID, JobTitle, Business, CourseID, CourseTitle, CourseDescription, MappingGuidelines, CourseDuration, CourseProcessArea, and CourseDeliveryMethod.

The RMT tool may perform mapping gap analysis and generate reports that identify gaps. The gap analysis identifies items not mapped to other items. For example, the mapping module identifies jobs not mapped to any roles or jobs not mapped to any training courses or roles not mapped to any training courses. A report may be generated that identifies those gaps.

The RMT tool may generate a segregation report. For example, the RMT tool implements segregation rules that may specify roles that can be combined for an individual or roles that should never be combined. A segregation report may include a matrix by role in one process area, a matrix by role across process areas and/or a matrix by job across process areas displaying roles that can never be mapped together.

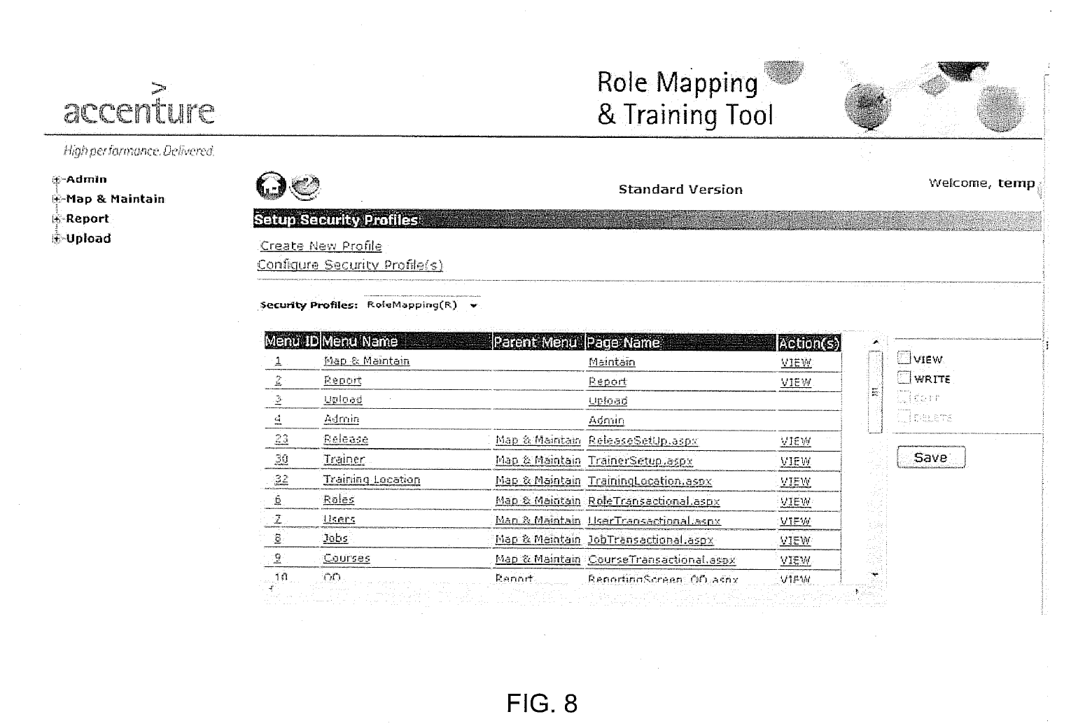

FIGS. 8-12 illustrate examples of screenshots that may be generated via the dashboard 306. FIG. 8 illustrates an example of a screen that may be used to generate security profiles. An administrator or other authorized user may set read and write access and other privileges for users or groups of users.

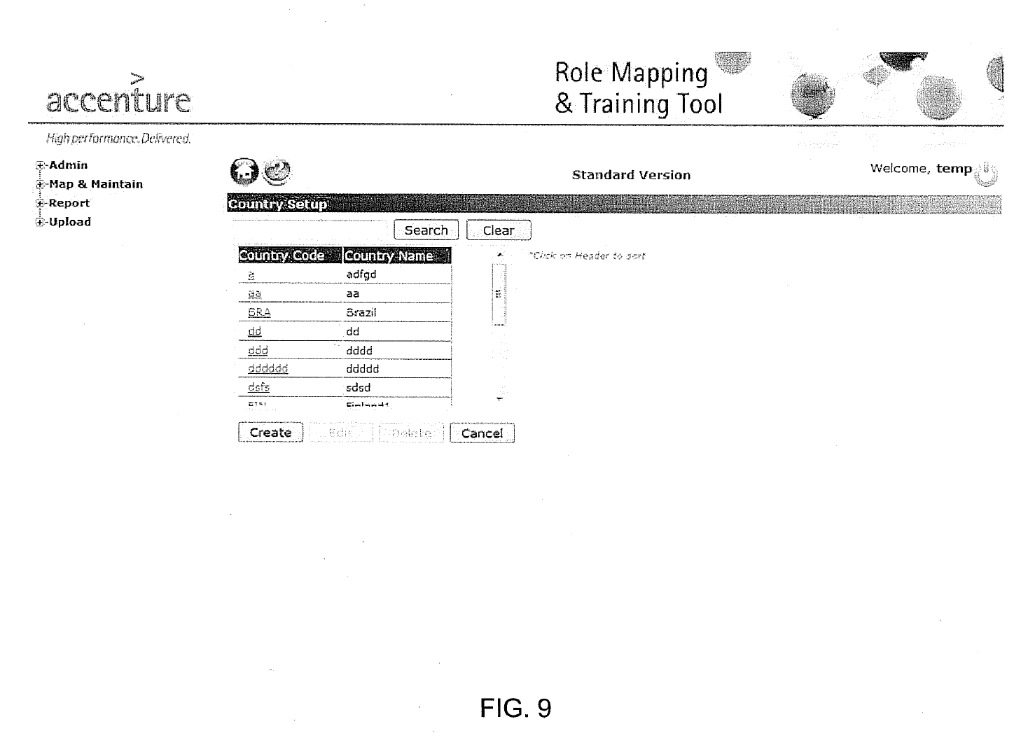

FIG. 9 shows an example of screen that may be used to enter geographic data, such as country, city state, etc. This data is stored in the data repository 103 along with other parameters. The geographic data may be used for mapping and scheduling. The geographic data may be used for SoD rules to specify that certain roles cannot be performed in the same region or may be used to map training resources to courses in the same region.

FIG. 10 shows an example of a screen that shows the ability to view and edit mappings to users. For example, as shown, the user of the dashboard can view the roles mapped to the user ID EP 123 and edit the mappings, such as adding or removing roles of the user having user ID EP 123. The same may be done for job and course mappings to the user. Also, this screen may be used to search for other users so the mappings for the other users can be viewed and edited.

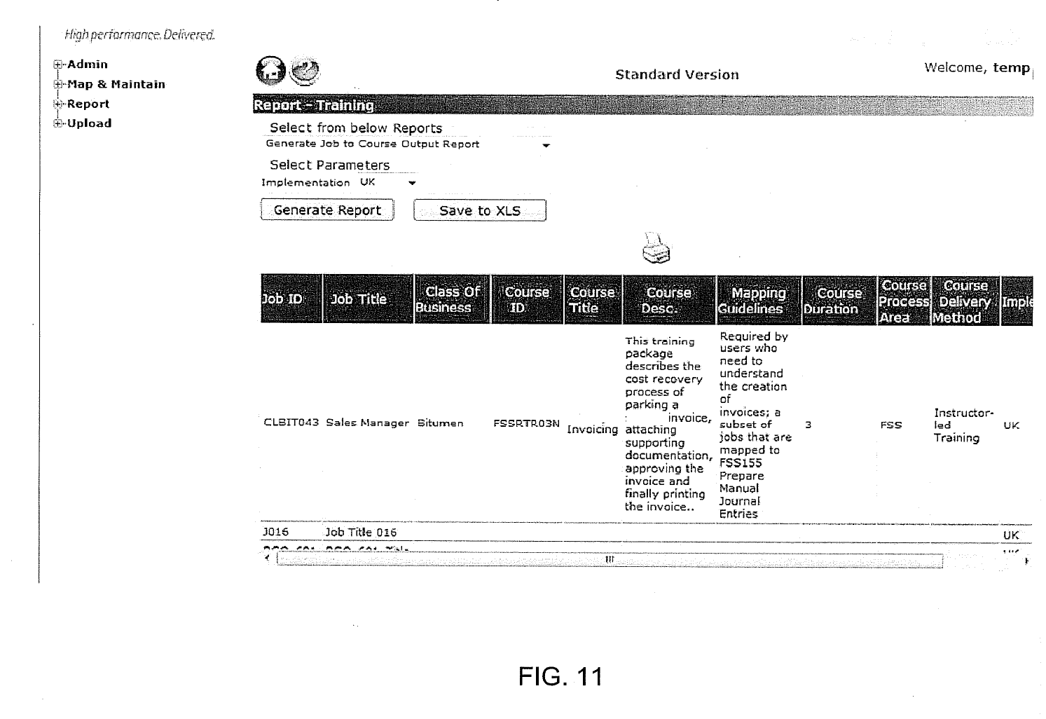

FIG. 11 shows an example of a screen that may be used to generate reports. For example, a type of report may be selected, such as job to course report, and parameters and implementations may be selected for the report. The report may be viewed via the screen or saved to a particular format.

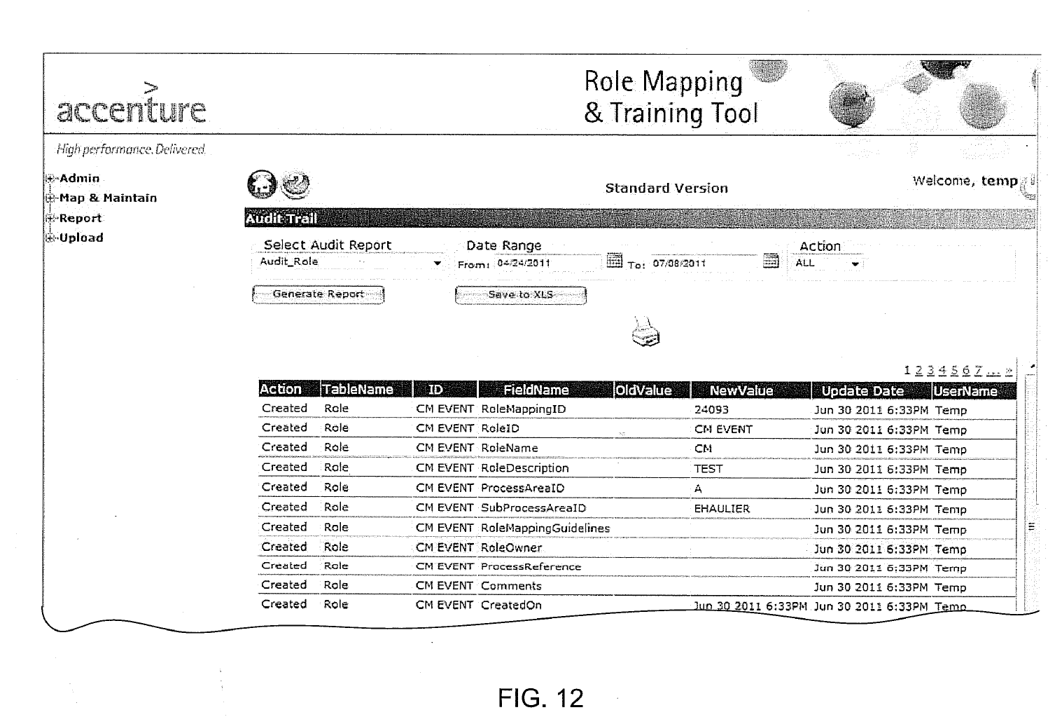

FIG. 12 shows an example of screen that may be used to view an audit report. The audit report enables a user to view the audit trail for changes made by users. For example, for each action performed by a user, a user name, time and date stamp, and other meta data for the action is stored and may be viewed through the audit report. In this example, it shows the audit trails for the actions of creating roles.

The screenshots shown in FIGS. 8-12 show examples of only some of the screens that may be generated via the dashboard 306. Other screens may be generated to allow users to perform other functions described herein.

While the embodiments have been described with reference to the disclosure above, those skilled in the art are able to make various modifications to the described examples without departing from the scope of the embodiments as described in the following claims, and their equivalents.

What is claimed is:

1. A role mapping and training (RMT) method for determining a training plan associated with an entity, the method comprising:
determining training course parameters for the entity;
determining role and job parameters for the entity;
mapping, by a processor, roles to jobs based on the role and job parameters;
mapping, by the processor, training courses to the jobs based on the training course parameters and the role to job mappings; and
determining a training plan from the mappings for training courses to jobs and the mappings for roles to jobs, wherein the training plan identifies at least one of the training courses for each job.

2. The method of claim 1, further comprising:
mapping, by the processor, individuals associated with the entity to the jobs, and determining a training plan comprises determining the training plan based on the mappings for individuals to jobs, and the training plan identifies at least one of the courses for each individual based on the mappings for individuals to jobs.

3. The method of claim 2, the method further comprising:
determining training resource parameters;
mapping, by the processor, training resources to the training courses based on the training resource parameters and the training course parameters, wherein the training plan includes the training resources for training course.

4. The method of claim 3, further comprising:
interfacing with an enterprise system operable to perform scheduling for the individuals;
sending scheduling information to the scheduling enterprise system to schedule the individuals for their respective training courses.

5. The method of claim 1, further comprising:
determining segregation rules; and
determining the mappings for roles to jobs based on the segregation rules, wherein the segregation rules specify roles that cannot be assigned to the same job.

6. The method of claim 5, further comprising:
identifying tasks for processes performed by the entity;
mapping each task to a role based on parameters for the tasks, wherein the mapping includes assigning some of the tasks to the same role if the tasks have a parameter that is the same;
determining combinations of roles that are assignable to the same job based on the segregation rules; and
selecting one or more of the combinations for the mappings of the roles to the jobs.

7. The method of claim 1, further comprising:
generating reports, wherein the reports comprise at least one of a listing of tasks, roles, jobs, courses, course resources, training plans, and schedules, a listing of mappings between tasks, roles, jobs, courses, course resources, training plans, and schedules, a mapping gap analysis, and a segregation report.

8. The method of claim 1, further comprising:
determining a hierarchy of mappings, wherein the mappings include mappings between tasks, individuals, the roles, and the jobs; and
analyzing the hierarchy of mappings based on an organization chart for the entity.

9. A role mapping and training (RMT) system comprising:
a data storage to store role and job parameters and training course parameters for an entity;
a processor to
retrieve the training course parameters for the entity;
retrieve the role and job parameters for the entity;
map roles to jobs based on the role and job parameters;
map training courses to the jobs based on the training course parameters and the role to job mappings; and
determine a training plan from the mappings for training courses to jobs and the mappings for roles to jobs, wherein the training plan identifies at least one of the training courses for each job.

10. The RMT system of claim 9, wherein the data storage stores parameters for individuals associated with the entity, and the processor is to map the individuals to the jobs based on the parameters for the individuals and the jobs, and wherein the training plan identifies at least one of the courses for each individual.

11. The RMT system of claim 10, wherein the data storage stores training resource parameters, and the processor is to map training resources to the training courses based on the training resource parameters and the training course parameters, wherein the training plan identifies at least one of the training resources for each training course.

12. The RMT system of claim 11, further comprising:
a data interface layer interfacing the RMT system with an enterprise system operable to perform scheduling for the individuals, and the processor is to send scheduling information to the scheduling enterprise system via the data interface layer to schedule the individuals for their respective training courses.

13. The RMT system of claim 9, wherein the data storage stores segregation rules, and the processor determines the mappings for roles to jobs based on the segregation rules, wherein the segregation rules specify roles that cannot be assigned to the same job.

14. The RMT system of claim 13, wherein the processor identifies tasks for processes performed by the entity, maps each task to a role based on parameters for the tasks, wherein the mapping includes assigning some of the tasks to the same role if the tasks have a parameter that is the same, determines combinations of roles that are assignable to the same job based on the segregation rules, and selects one or more of the combinations for the mappings of the roles to the jobs.

15. The RMT system of claim 9, wherein the processor generates reports, wherein the reports comprise at least one of a listing of tasks, roles, jobs, courses, course resources, training plans, and schedules, a listing of mappings between tasks, roles, jobs, courses, course resources, training plans, and schedules, a mapping gap analysis, and a segregation report.

16. The RMT system of claim 9, wherein the processor determines a hierarchy of mappings, wherein the mappings include mappings between tasks, individuals, the roles, and the jobs, and analyzes the hierarchy of mappings based on an organization chart for the entity.

17. A non-transitory computer readable medium storing computer readable instructions that when executed by a processor performs a method for determining a training plan associated with an entity, the method comprising:
determining training course parameters for the entity;
determining role and job parameters for the entity;
mapping roles to jobs based on the role and job parameters;
mapping training courses to the jobs based on the training course parameters and the role to job mappings; and
determining a training plan from the mappings for training courses to jobs and the mappings for roles to jobs, wherein the training plan identifies at least one of the training courses for each job.

18. The non-transitory computer readable medium of claim 17, wherein the method further comprises:
mapping individuals associated with the entity to the jobs, and determining a training plan comprises determining the training plan based on the mappings for individuals to jobs, and the training plan identifies at least one of the courses for each individual based on the mappings for individuals to jobs.

19. The non-transitory computer readable medium of claim 18, wherein the method further comprises:
determining training resource parameters;
mapping training resources to the training courses based on the training resource parameters and the training course parameters, wherein the training plan includes the training resources for training course.

20. The non-transitory computer readable medium of claim 17, wherein the method further comprises:
identifying tasks for processes performed by the entity;
mapping each task to a role based on parameters for the tasks, wherein the mapping includes assigning some of the tasks to the same role if the tasks have a parameter that is the same;
determining combinations of roles that are assignable to the same job based on segregation rules, wherein the segregation rules specify roles that cannot be assigned to the same job; and
selecting one or more of the combinations for the mappings of the roles to the jobs.
